(19) United States
(12) Patent Application Publication
(10) Pub. No.: US 2025/0263007 A1
(43) Pub. Date: Aug. 21, 2025

(54) Sleeping System for SUV

(71) Applicants: Kyle Bell, Fredrick, CO (US); Andrew C. Jacobson, Aurora, CO (US)

(72) Inventors: Kyle Bell, Fredrick, CO (US); Andrew C. Jacobson, Aurora, CO (US)

(21) Appl. No.: 19/057,049

(22) Filed: Feb. 19, 2025

Related U.S. Application Data
(60) Provisional application No. 63/555,450, filed on Feb. 20, 2024.

(51) Int. Cl. B60P 3/34; B60N 2/20

(52) U.S. Cl. CPC B60P 3/34; B60N 2/206

(57) ABSTRACT

A sleep system configured to be mounted in the cargo area behind the second-row seats of an SUV. The sleep system comprises a base platform positioned a predetermined distance above the floor of the cargo area by legs and associated support structure, and a slidably-extendable cantilevered platform that is positioned over or under the base platform in a stowed configuration and is extended towards the front seats to be generally planar with the base platform in a deployed configuration. The system typically uses a multi-function bracket connects with the stow and deployment connectors to secure the system in each of the stowed and deployed configurations respectively.

### RELATED REFERENCES

This application incorporates by reference and claims priority to U.S. Provisional Patent Application No. 63/555,450 entitled Sleeping Platform for SUV filed on Feb. 20, 2024 and having the same inventors of the present application.

### BACKGROUND

Overlanding has become a popular activity in the United States and worldwide involving vehicular travel to remote wilderness locations while carrying in and on the vehicle all the necessary supplies to be relatively self-sufficient for multiple days. Most often, the vehicles comprise off-road capable SUVs that offer high ground clearance, 4-wheel drive, and a sufficient interior space to contain the necessary supplies and also provide an enclosed sleeping solution.

To organize the interior of a vehicle and make the most of its volume, storage and sleep systems that install in the back of an SUV are known. These systems can include a combination of drawers and shelves and importantly include a sleeping platform. Often the systems are wholly or partially customized to a particular vehicle to maximize the utilization of the provided interior space. The systems may also include tables that can be pulled out from back of the vehicle's tailgate to serve multiple purposes, such as food preparation.

The systems are typically transformable between several configurations depending on circumstances. For instance, while traveling, the systems are often compacted to be fully stowed within the vehicle's cargo area allowing the second-row seats to be utilized by passengers. When the vehicle is parked and the tailgate open, the system may include drawers and tables that can extend outside of the vehicle from the tailgate to permit a user to access items stored in the drawers and/or permit the user to prepare meals on elevated flat surfaces. For sleeping, the systems can include platforms that extend out towards folded rear seats to provide users with a flat area long enough to lie upon in a prone or supine orientation.

Key considerations in designing transformable storage and sleep system for overlanding is making them easy and quick to deploy and stow while also making them as solid and rattle free as possible especially while the vehicle is traveling over variable terrain.

### BRIEF DESCRIPTION OF THE DRAWINGS

FIG. 1 is a perspective view of the sleep system secured in an SUV with the sleep platform being in a deployed configuration according to an embodiment of the present invention.

FIG. 2 is a perspective view of the sleep system secured in an SUV with the sleep platform being in a stowed configuration according to an embodiment of the present invention.

FIG. 3 is a perspective side view of the sleep system with the sleep platform being in a deployed configuration according to an embodiment of the present invention.

FIG. 4 is a perspective side view of the sleep system with the sleep platform being in a stowed configuration according to an embodiment of the present invention.

FIG. 5 is a partial perspective front end side view of the sleep system in the deployed configuration showing primarily the cantilever platform thereof according to an embodiment of the present invention.

FIGS. 6A-D show perspective top and bottom views of the coupling mechanisms employed to secure the cantilevered platform to the base platform in the deployed configuration according to an embodiment of the present invention.

FIGS. 7A-C show perspective views of the coupling mechanisms employed to secure the cantilevered platform to the base platform in the stowed configuration according to an embodiment of the present invention.

FIGS. 8A-B show back and side views of the multi-function bracket according to an embodiment of the present invention.

FIG. 9 is a perspective view of the base panel stow connector according to an embodiment of the present invention.

FIG. 10 is a perspective view of the base panel deployment connector according to an embodiment of the present invention.

### DETAILED DESCRIPTION

### Overview

Embodiments of the present invention comprise a sleep system configured to be mounted in the cargo area behind the second-row seats of an SUV. The sleep system comprises a base platform positioned a predetermined distance above the floor of the cargo area by legs and associated support structure, and a slidably-extendable cantilevered platform that is positioned on top of the base platform in a stowed configuration and is extended towards the front seats to be generally planar with the base platform in a deployed configuration.

The system utilizes a pair of multi-function brackets mounted to the bottom of the cantilevered platform to interact with a pair of stow connectors and a pair of deployment connectors, both on the base platform, to secure the cantilevered platform in the stowed and deployed configurations respectively. The base platform further includes a pair of pivotal J-hook connectors that are frictionally received in respective left and right slots in the cantilevered platform to help secure the system in the deployed configuration. Advantageously, the coupling mechanisms act to secure the sleep system so that the system does not rattle during vehicle use in either configuration.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive, rather the term is inclusive meaning “either or both”.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, upper, lower, vertical, horizontal, back, front, lateral, outwardly, and upwardly are relative to each other and are dependent on the specific orientation of an applicable element or article, and are used accordingly to aid in the description of the various embodiments and are not necessarily intended to be construed as limiting.

Unless otherwise indicated or dictated by context, the terms “approximately” and “about” mean+−20%. Unless otherwise indicated or dictated by context, the term “substantially” means+−10%. The term “generally” means for the most part.

### An Embodiment of a Vehicle Mounted Sleep System

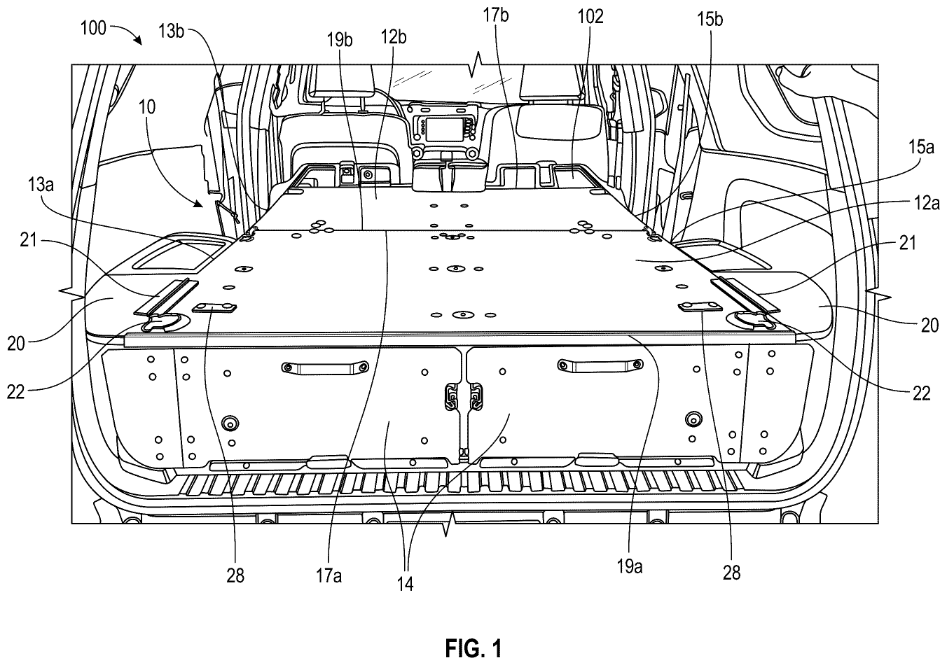

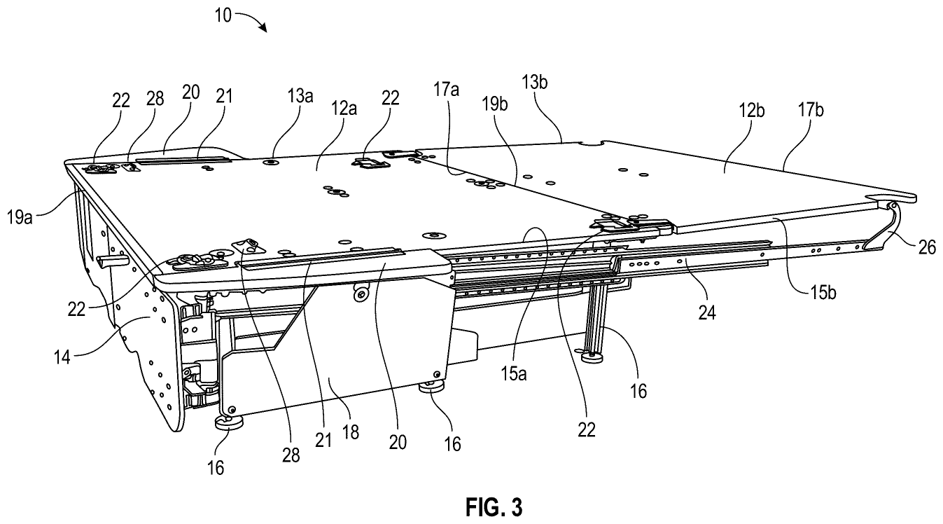

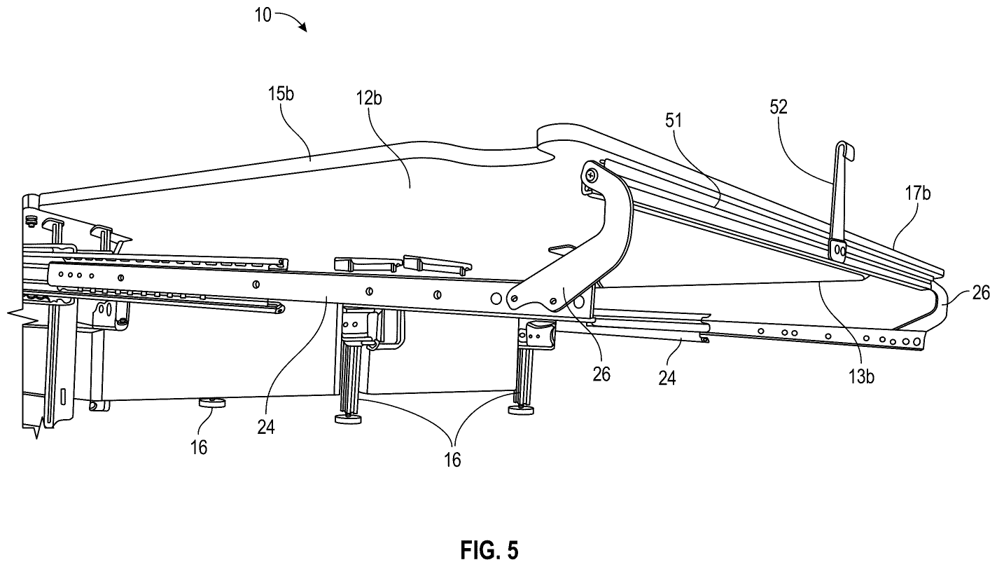

FIGS. 1-5 illustrate a sleep system 10 designed to be mounted in a cargo hold of an SUV 100. FIGS. 1 & 2 specifically show the sleep system mounted in the cargo hold of an SUV in the deployed and stowed configurations respectively; whereas, FIGS. 3-5 illustrate the embodiment alone in both configurations.

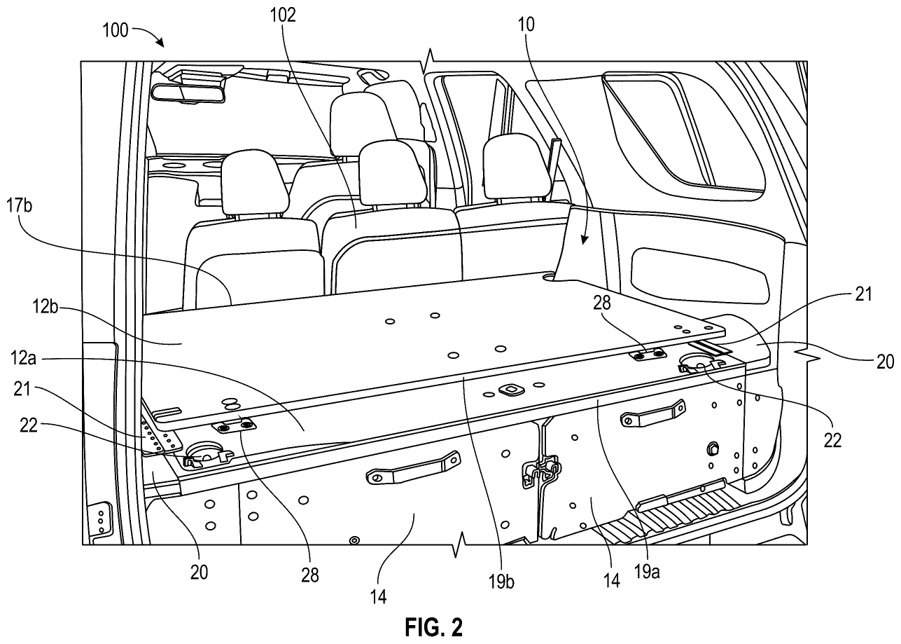

With reference to the Figures, the sleep system 10 generally comprises two planar sections that form a sleeping platform when joined in deployed configuration: a base platform 12a and a cantilevered platform 12b. The platform sections are typically coupled together by way of one or more slide brackets (typically a pair) 24 that permit the movement of the cantilevered platform between a stowed configuration wherein it is positioned substantially over the base platform as seem in FIGS. 2 & 4, and a deployed configuration wherein the cantilevered platform is located in front of and substantially planar with the base platform in FIGS. 1 & 3. As the name implies the cantilevered platform is supported in a cantilevered manner relative to the base platform by the slide brackets. The base platform is typically fixedly positioned above a floor of the cargo area by a support structure that can comprise a plurality of legs 16 with associated feet. Turnbuckles and other means (not shown) can be used to secure the base platform and support structure in place within the cargo hold.

The base and cantilevered platforms 12a&b are typically comprised of a composite panel of various layers of birchwood of which one or more of the top and bottom surface layers can comprise birchwood veneers or other materials more suited to taking the abuse a sleep system might be subjected while retaining a desirable appearance. Two surface layers used in certain variations include Richlite composite sheets made by the Richlite Company of Tacoma, Washington, and a phenolic film. Surface layers of other suitable materials may be used in other variations as well.

The top surface of the respective platforms 12a&b form a sleep surface on top of which a mattress, a sleeping pad padding, a sleeping bag and/or other bedding can be placed making the platform suitable to be slept upon by a user. The platforms may include other features mounted to them. As shown, proximate each corner of the base platform 12a, tie down D-ring brackets 22 are provided as convenient lash points for straps and ropes by which to secure items placed thereon. As shown and best seen in FIGS. 1 & 4 hinged side panels 20 are provided along the left and right edges of the base platform. These panels act to extend the planar surface to the respective walls of the vehicle's cargo bay. By flipping these panels up along the hinges 21 access to storage areas there beneath is provided. Also mounted to the platforms are several brackets discussed in detail below that facilitate the securement of the cantilevered platform 12b to the base platform 12a in both the stowed and deployed configurations.

As indicated above the base platform 12a is positioned a predetermined distance above the floor of the cargo area by way of a plurality of legs 16 and associated feet that are secured to and extend downwardly from the bottom surface of the base platform. The space between the cargo area floor and the bottom surface of the base platform 12a forms a volume in which travel supplies and any other desired cargo can be stored. In some variations, drawers 14 accessible from the tailgate of the SUV can be installed in this space as shown in FIGS. 1 and 3 for instance. As also shown in FIG. 3, vertical side panels 18 may be provided act to define the bounds of the storage cubbies discussed above providing separation of the cubbies from the slides of the drawers and the slide brackets 24 of the cantilevered platform 12b.

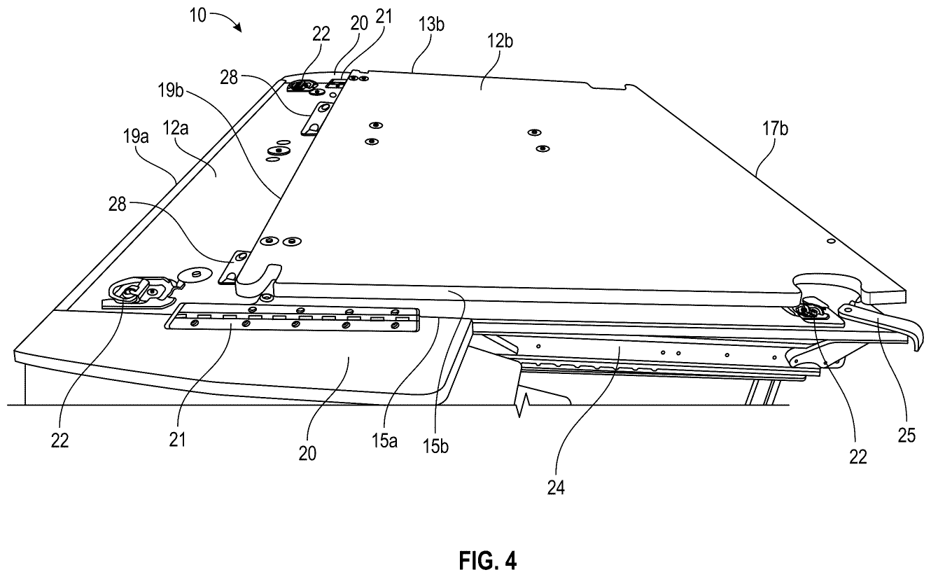

One of the pair of cantilever slide brackets 24 can be best seen in an extended configuration in FIGS. 3 & 5 corresponding to the deployed configuration of the sleep system 10 and in the retracted configuration in FIG. 4 corresponding to the stowed configuration of the sleep system. Each cantilever slide bracket is mounted to bottom side of the base platform 12a proximate one of its left and right edges 13a & 15a. The slides are mounted in such a fashion that they are angled downwardly several degrees such that the slide axis of each slide is neither parallel with the platforms 12a & b nor horizontal. The slides are each designed to support a cantilevered load of 500 pounds at its front end when fully extended easily supporting the weight of the cantilevered platform and two people sleeping thereon. An inverted metal hook member 26 rises upwardly from the end of each cantilever slide bracket to which it is fixedly attached at a first end. A second end of the hook member is pivotally attached to an end of an elongated extruded bar 51, typically made of aluminum, which is secured to the bottom of the cantilevered platform 12b proximate the platform's front edge 17b. In some variations, an upwardly extending hooked arm 52 may be provided that is attached to the extruded bar. This optional arm can hook to bracketry provided on the back of some stowed second row seats to provide additional support in use scenarios wherein the weight incident on the cantilever platform is near, at, or exceeds the rating of the slide brackets. Given the 500 pound capacity of slide brackets specified in certain embodiments, the hooked arm is rarely required.

The foregoing configuration causes the cantilevered platform 12b to be lowered vertically from a position where its flat top surface is located substantially above the top surface of the base platform 12a in the stowed configuration to a position where the cantilever top surface is substantially planar with the base top surface in the deployed position. Conversely, when moved from the deployed configuration to the stowed configuration, the cantilevered platform 12b rises.

To facilitate the substantially rattle-free securement of the system in both the stowed and deployed configurations, a plurality of connectors attached to both the cantilevered platform 12b and the base platform 12a are used. The connectors comprise: a pair of multi-function brackets 34 attached to the bottom surface of the cantilevered platform proximate the front edge thereof; a pair of stow connectors 28 attached to the top surface of the base platform proximate the back edge 19a of the base platform; and a pair of deployment connectors 32 attached to the bottom surface of the base platform proximate the front edge 17a thereof. Variations of the system including the illustrated system further include left and right J-hook connectors 25 that are pivotally coupled to the base platform generally proximate the intersection of the base platform's front edge 17a and the respective left and right edges 13a & 15a. The J-hook connectors are configured to couple with corresponding left and right slots 54 that extend inwardly from the left and right edges 13b & 15b of the cantilevered platform proximate its rear edge 19b.

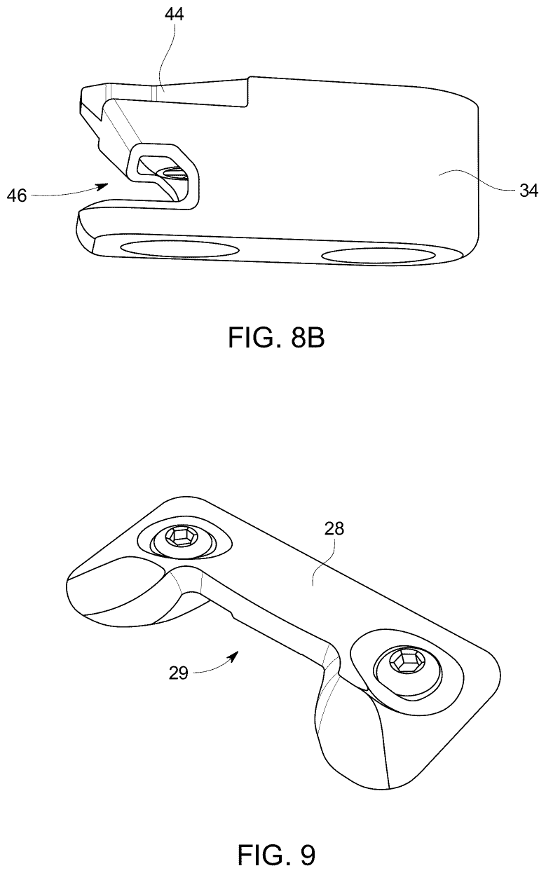

The multi-function bracket 34 is best illustrated in FIGS. 8a-b. It is typically fabricated from an unreinforced or reinforced plastic such as glass filled or unfilled nylon. The brackets can be manufactured using any suitable means, such as injection molding, but in some variations the brackets are 3d printed obviating the need for expensive specialized tooling and permitting rapid modification of the part during production as circumstances require. The bracket is characterized by upper and lower slots 44 & 46 that extend inwardly from the back side thereof. These slots are configured to interface with the stow bracket 28 and the deployment connectors 32 respectively to secure the cantilevered platform in place as is discussed in greater detail below.

The stow connector 28 is best illustrated in FIG. 9. Like the multi-function bracket, it is typically fabricated from an unreinforced or reinforced plastic such as glass filled or unfilled nylon. Further, the connector can be manufactured using any suitable means, such as injection molding, but in some variations the brackets are 3d printed obviating the need for expensive specialized tooling and permitting rapid modification of the part during production as circumstances require. The bracket is typically secured to the top surface of the base platform by a pair of screws or other fasteners and comprises a lip that forms a recess 29 with the underlying top surface of the base platform that interfaces with the lower slot 46 of the multi-function bracket 34 when the system is in the stowed configuration as is discussed in greater detail below.

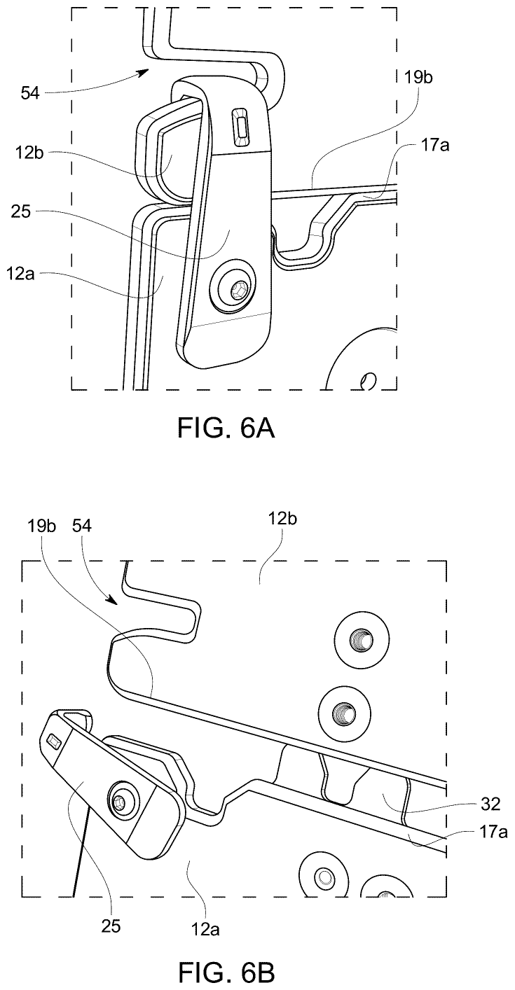

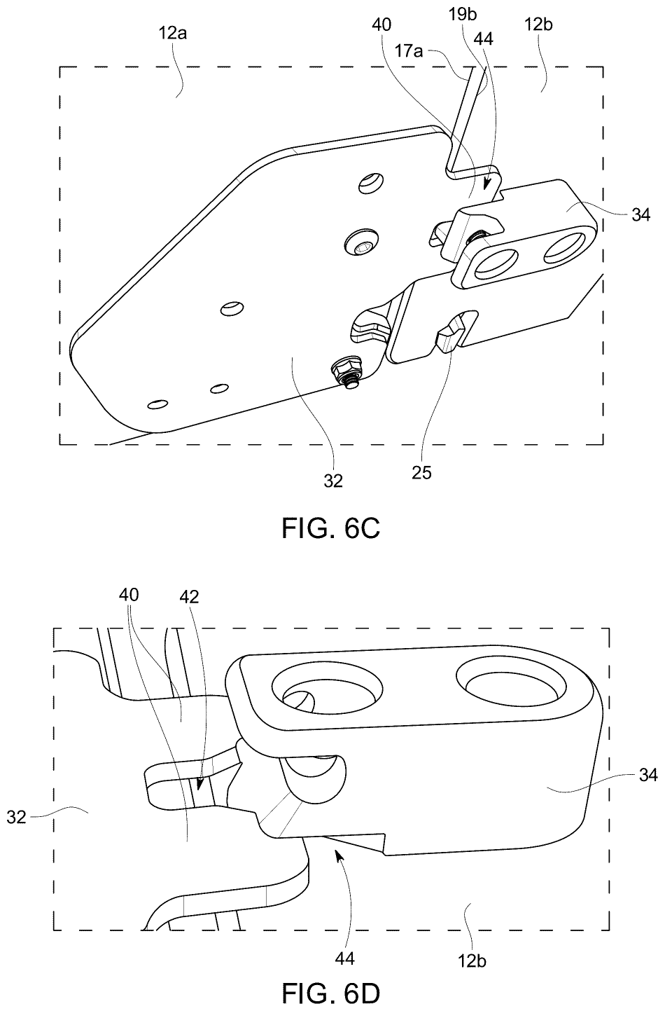

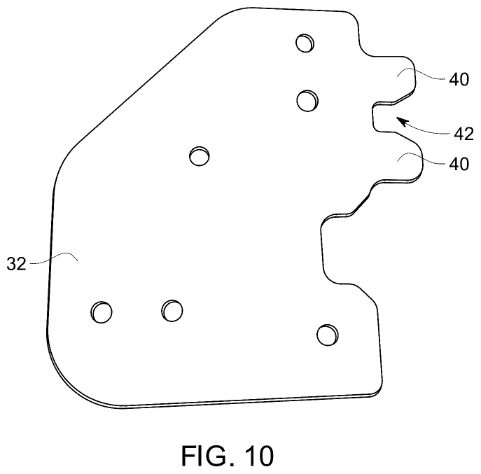

The deployment connector 32 is best illustrated in FIG. 10. The connector typically comprises a shaped metal plate that fixedly attached to the base platform with a plurality of fasteners. The plate includes two substantially parallel fingers 40 that extend outwardly from the front edge of the base platform 17a (see FIG. 6b-c) and form a gap 42 therebetween. The fingers are received in the upper slot 44 of the multi-function bracket with the gap straddling a center portion of the multi-function bracket when the system is in the deployed configuration. The top surface of the fingers rest against the bottom surface of the cantilevered platform to help support the cantilevered platform as is discussed in greater detail below.

The J-hook connector 25 is best illustrated in FIG. 6A. Like the multi-function bracket 34 and stow connector 28, it is typically fabricated from an unreinforced or reinforced plastic such as glass filled or unfilled nylon. Further, the connector can be manufactured using any suitable means, such as injection molding, but in some variations the brackets are 3d printed obviating the need for expensive specialized tooling and permitting rapid modification of the part during production as circumstances require. The connector is typically secured to the top surface of the base platform 12a by a single bolted fastener sandwiched between two washers proximate its proximal end permitting it to be pivoted from unsecured and secured positions. The hooked distal end of the J-hook connector is configured to be pivotally received into the corresponding slot 54 in the cantilevered platform 12b to secure the platforms together in the deployed configuration as is discussed in greater detail below.

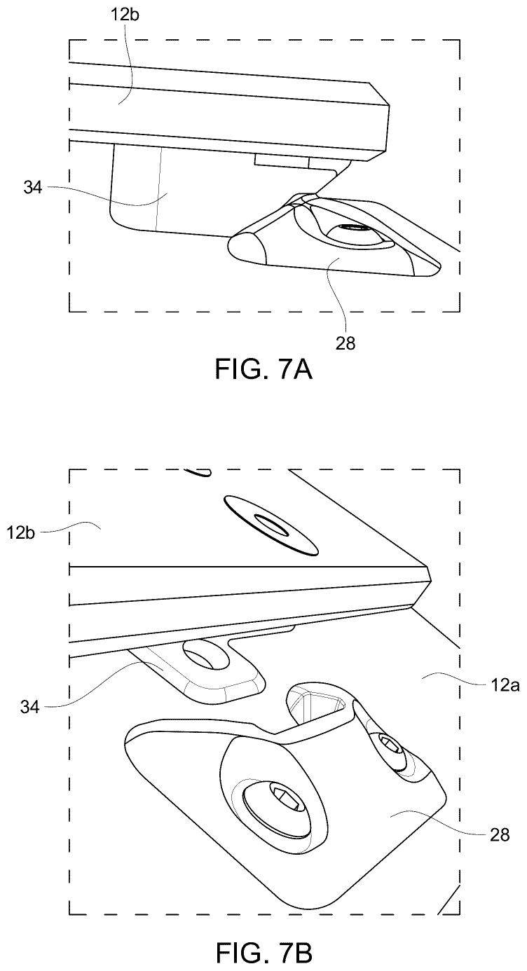

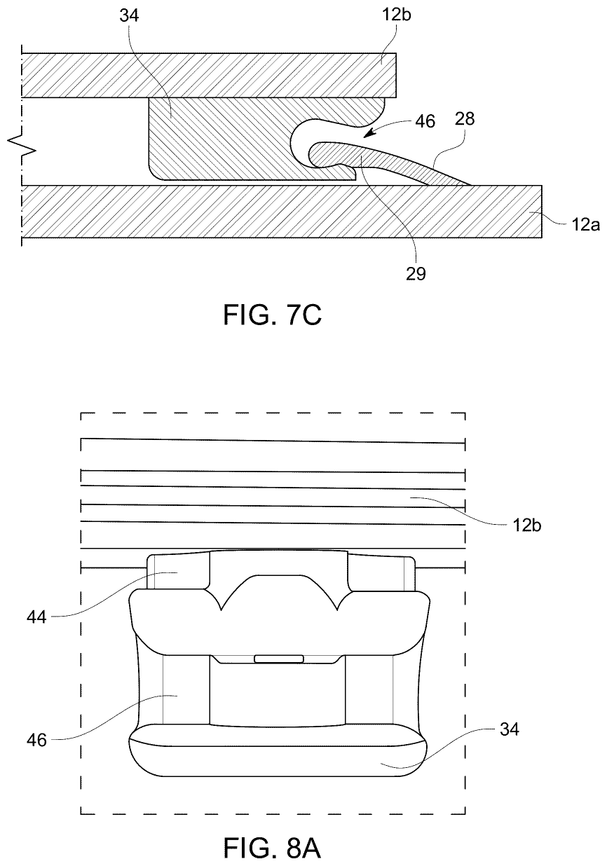

FIGS. 2 and 4 illustrate the sleep system 10 in the stowed configuration. FIG. 2 further shows the system installed in an SUV 100. Of significance in some variations, the stowed configuration confines the sleep system to the SUV's cargo hold permitting the second row of seats 102 to be deployed and usable. The seats need only be fold down and/or forwardly when the sleep system is in its deployed configuration. Advantageously, the system can be left in place within the vehicle and not impact its ability to carry a driver and 3-4 passengers. The cantilevered platform 12b is held in place above and overlying the base platform by the slide brackets 24 by way of the hook members 26 pivotally interfacing with the cantilevered platform proximate its front edge 17b, and through the interconnection of the multi-function brackets 34 and the stow connectors 32 proximate the rear edge 19b of the cantilevered platform. Specifically, with reference to FIGS. 7A-C, the lower slot 46 of the multi-function bracket interlocks with the lip 29 of the stow connector to snappily secure the bracket and connector together. The interconnection can be easily released by a user with a firm push forwardly of the cantilevered platform, which will cause it to slide forwardly along the slide brackets.

FIGS. 1& 3 illustrate the sleep system in the deployed configuration with FIG. 1 showing the system installed in the SUV with the second row of seats 102 folded forwardly. In the deployed configuration the base and cantilevered platforms 12a&b are aligned in a plane creating an elongated substantially flat surface suitable for sleeping. The cantilevered platform is secured in place in front of the base platform by way of the slide brackets 24 and associated hook members 26 proximate the front edge 17b and through the deployment connectors 32 and the multi-function connector 34 proximate the rear edge 19b. Furthermore, J-hook connectors 25 are provided proximate the front edge 17a of the base platform that are securely received in slots 54 along the left and right edges 13b & 15b of the cantilevered platform to fixedly secure the platforms together and prevent them from sliding apart during use.

Operationally to deploy a sleep system 10 in the stowed configuration, a user typically accesses the back of the sleep system from a rear hatch or tailgate of the SUV 100. He/she pushes the cantilevered platform 12b forwardly from the rear edge 19b of the platform. As the cantilevered platform moves forwardly, it also is vertically lowered as a result of the downwardly canted slide brackets 24. When fully extended the cantilevered platform's rear edge is typically located several inches ahead of the front edge 17a of the base platform 12a and in front of the fingers 40 of the stow connector 32 permitting the rear edge of the multi-function bracket 34 to clear the fingers of the stow connectors. The user then slides the cantilevered platform rearwardly until the fingers 40 are received in the respective upper slot 44 of the multi-function bracket and the front edge 17a of the base platform is flush and planer with the rear edge 19b of the cantilever bracket as shown in FIGS. 6B and 6D. After the platform edges are brought flush with each other the user can than rotate the J-hook connectors 25 from their undeployed positions as shown in FIG. 6B into its deployed position shown in FIG. 6B wherein the distal hooked ends of the connector are received in slots 54 along the respective left and right edges 13b & 15b of the cantilevered platform. The J-hook connectors are frictionally held in the slots to prevent the platforms from separating during use.

The deployed platform is substantially rattle free when the associated SUV is driven with the sleep system deployed and as such the sleep system can remain in the deployed position as long as desired. When not being used as a sleep platform, the surface of the deployed system can be used to store cargo and supplies thereon. As can be appreciated, tie down loops 22 are provided on the corners of the base platform 12a and these can be used to secure cargo as desired. However, if the users desire to utilize the second row of seats 102 to transport passengers, the system must be configured in its stowed configuration to permit the second row of seats to be unfolded and deployed.

To reconfigure a deployed sleep system into it stowed configuration, the user first pivots the J-hook connectors 25 out of the slots 54 along the edges of the cantilevered platform 12b. Next, he/she slides the cantilevered platform forwardly until the rear edge 19b of the platform clears the fingers 40 of the stow connectors 32. The user then pivots the rear edge of the cantilevered platform upwardly enough so that the bottom surface of the platform and the multi-function brackets 34 clear the top surface of the base platform 12a. Next, the user either pushes or pulls the cantilevered platform rearwardly along its slide brackets 24. Of note, the pivotal connection between the cantilevered platform and the hook members 26 permits the user to pivot the cantilevered platform upwardly when it is not connected with the deployment connectors 32. As the cantilevered platform is moved rearwardly it rises vertically because of the canted angle of the slide brackets moving it over the base platform 12a. Once nearly fully retracted with reference to FIGS. 7a&c, the user aligns the multi-function brackets 34 with the corresponding stow connectors 28 on the top surface of the base platform and slides the lower slot 46 of the multi-function bracket is slid into the lip 29 of the stow connector interlocking each and securing the cantilevered platform in the stowed position. Also, of note, the operation of configuring the platforms between the stowed and deployed configurations does not require the use of tools permitting easy use in the field.

### Variations and Alternative Embodiments

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention

For instance, the system illustrated places the cantilever platform above the base platform in the stowed configuration. This maximizes the amount of space below the base platform available for storage allowing the installation of larger drawers. However, in other variations, the system can be configured to have the cantilever platform slide below the base platform wherein instead of being generally parallel with the base platform from above, it is generally parallel with the base platform from below. As can be appreciated the configuration and angles of the slide brackets would vary to accommodate this variation.

We claim:

1. A sleep system having deployed and stowed sleep configurations for installation into a cargo area of a vehicle, the sleep system comprising:
a base platform, the base platform being generally rectangular having (1) a base front edge, (2) a base back edge, (3) base left and right side edges extending between intersections with the left and right ends of the respective base front and base back edges, (4) a base top surface, and (5) a base bottom surface;
a support structure configured to elevate the base platform over a floor of the cargo area;
a cantilevered platform, the cantilevered platform being generally rectangular having (i) a cantilever front edge, (ii) a cantilever back edge, (iii) cantilever left and right side edges extending between intersections with the left and right ends of the respective cantilever front and back edges, (iv) a cantilever top surface, and (v) a cantilever bottom surface, the cantilevered platform being generally parallel with the base platform in a stowed position and the cantilevered top surface and the base top surfaces being generally planar in the deployed configuration;
one or more slide brackets, each slide bracket of the one or more slide brackets including (a) a bracket back section connected with the base platform, and (b) a bracket front section connected with the cantilevered platform, the bracket front section being linearly slidable along a bracket axis relative to the rear bracket between the stowed configuration and the deployed configuration; and
one or more cantilever brackets attached to the cantilever platform, and one or more base brackets attached to the base platform, wherein combinations of the one or more base brackets and the one or more cantilever brackets interconnect to secure the cantilever platform in the stowed and deployed configurations.

2. The sleep system of claim 1, wherein the one or more cantilever brackets comprise one or more multi-function brackets attached to the cantilever bottom surface proximate the cantilever front edge, and the one or more base brackets comprise (1) one or more stow connectors attached to the base top surface proximate the base back edge, a first stow connector of the one or more stow connectors configured to connect with a first multi-function bracket of the one or more multi-function brackets in the stowed position and (2) one or more deployment connectors attached to the base bottom surface proximate the base front edge, a first deployment connector of the one or more deployment connectors configured to connect with the first multi-function bracket in the deployed configuration.

3. The sleep system of claim 1, wherein the cantilever platform overlies the base platform when in the stowed configuration.

4. The sleep system of claim 1, wherein the one or more base brackets and the one or more cantilever brackets are configured to connect without the use of one or more tools.

5. The sleep system of claim 2, further comprising:
base left and right slots extending inwardly from the cantilever left and right sides edges respectively generally proximate the intersections with the cantilever back edge; and
left and right hook connectors pivotally coupled to the base platform proximate the intersection of the base front edge and the respective base left and right side edges;
wherein each left and right hook connector is configured to be received in the respective base left and right slot when in the deployed configuration.

6. The sleep system of claim 5, wherein the one or more multi-function brackets, the one or more stow connectors, the one or more deployment connectors, and the left and right J-hook connectors are configured for operation without a use of one or more tools.

7. The sleep system of claim 2, wherein (i) the one or more slide brackets comprise left and right slide brackets, (ii) the one or more multi-function brackets further include a second multi-function bracket with the first multi-function bracket being located proximate the cantilever left side edge and the second multi-function bracket being located proximate the cantilever right side edge, and (iii) the one or more stow connectors further include a second stow connector with the first stow connector being located proximate the cantilever left side edge and the second stow connector being located proximate the cantilever right side edge.

8. The sleep system of claim 5, wherein (i) the one or more slide brackets comprise left and right slide brackets, (ii) the one or more multi-function brackets further include a second multi-function bracket with the first multi-function bracket being located proximate the cantilever left side edge and the second multi-function bracket being located proximate the cantilever right side edge, and (iii) the one or more stow connectors further include a second stow connector with the first stow connector being located proximate the cantilever left side edge and the second stow connector being located proximate the cantilever right side edge.

9. The sleep system of claim 1 wherein the support structure comprises four or more legs.

10. The sleep system of claim 1, wherein the one or more slide brackets are each pivotally connected to the cantilever platform.

11. The sleep system of claim 3, wherein the bracket axis of each slide bracket of the one or more slide brackets forms an acute angle relative to the plane of the cantilever platform when in the deployed configuration.

12. The sleep system of claim 5, wherein the one or more multi-function brackets, the one or more stow connectors and the left and right J-hook connectors are comprised of a polymeric material.

13. The sleep system of claim 12, wherein the one or more multi-function brackets, the one or more stow connectors and the left and right J-hook connectors are 3D printed.

14. The sleep system of claim 2, wherein the one or more deployment connectors comprise a metal plate.

15. The sleep system of claim 5, wherein the sleep system is substantially rattle-free in either the deployed or stow configurations when the vehicle is in operation.

16. The sleep system of claim 1 in combination with the vehicle, the vehicle being an SUV, wherein the sleep system is received in and secured to the cargo hold.

17. The sleep system of claim 16, wherein the SUV includes a second row of seating behind a first row with the second row being foldable from a deployed position permitting one or more people can sit in the second row of seating and a folded position with the second row is folded forward to increase the size of the cargo area, and wherein the second row is in the folded position and the sleep system is in its deployed configuration.

18. The sleep system of claim 16, wherein the SUV includes a second row of seating behind a first row with the second row being foldable from a deployed position permitting one or more people can sit in the second row of seating and a folded position with the second row is folded forward to increase the size of the cargo area, and wherein the second row is in the deployed position and the sleep system is in its stowed configuration.

19. A method of using the combination of claim 18, the method comprising:
folding the second row into a folded position;
from a tailgate of the SUV, releasing any of the one or more cantilever brackets secured to any of the one or more base brackets in the stowed configuration;
sliding the cantilevered platform forwardly extending the one or more slide brackets until the cantilevered platform is positioned substantially in front of the base platform; and
abutting the base front edge against the cantilever rear edge and coupling at least one cantilever bracket with at least one base bracket of the respective one or more cantilever and base brackets to secure the cantilever platform in the deployed configuration.

20. A method of using the combination of claim 17, the method comprising:
releasing any of the one or more cantilever brackets secured to any of the one or more base brackets in the deployed configuration;
sliding the cantilevered platform rearwardly over the base platform retracting the one or more slide brackets; and
coupling at least one cantilever bracket with at least one base bracket of the respective one or more cantilever and base brackets to secure the cantilever platform in the stowed configuration.
